(19) United States
(12) Patent Application Publication
(10) Pub. No.: US 2005/0180306 A1
(43) Pub. Date: Aug. 18, 2005

(54) Disk labeling kit and method

(76) Inventors: Jeffrey M. Valley, Corvallis, OR (US); Tim Myers, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/768,555

(22) Filed: Jan. 29, 2004

(51) Int. Cl. G11B 7/24

(52) U.S. Cl. 369/275.4

(57) ABSTRACT

A disk labeling kit and method of operation allows application of an after-market label to an optical disk. In one embodiment, a reactive coating is applied to a non-data surface of the optical disk. Additionally, speed and angular orientation indicia are applied to the disk. And further, an image is applied to the reactive coating using the speed and angular orientation indicia.

### RELATED APPLICATIONS

This patent application is related to U.S. patent application Ser. No. 10/661,753, titled “Optical Disk Drive Modified for Speed and Orientation Tracking”, filed on 12 Sep. 2003, commonly assigned herewith, and hereby incorporated by reference.

This patent application is related to U.S. patent application Ser. No. 10/661,722, titled “Optical Disk Drive Modified for Speed and Orientation Tracking”, filed on 12 Sep. 2003, commonly assigned herewith, and hereby incorporated by reference.

### BACKGROUND

A large number of optical disks, such as CDs and DVDs have been sold. Many are pre-recorded, such as musical CDs, movies on DVDs and software on CDs. Most pre-recorded disks have professional, factory-printed labels. However, very large numbers of blank CDs and DVDs have been sold. Consumers record their own music, photos, home video and data onto these CDs and DVDs. Consumer camcorders are now saving data to DVDs, and consumer-recorded CDs, containing music and/or photographs, are ubiquitous. Unfortunately, the vast majority of consumer-recorded (previously blank) CDs and DVDs have only very crude labels, typically hand-drawn with a felt-tipped pen. As a result, such CDs and DVDs tend to have a rather unprofessional appearance.

### SUMMARY

A disk labeling kit and method of operation allows application of an after-market label to an optical disk. In one embodiment, a reactive coating is applied to a non-data surface of the optical disk. Additionally, speed and angular orientation indicia are applied to the disk. And further, an image is applied to the reactive coating using the speed and angular orientation indicia.

### BRIEF DESCRIPTION OF THE DRAWINGS

The following detailed description refers to the accompanying figures. In the figures, the left-most digit(s) of a reference number identifies the figure (Fig.) in which the reference number first appears. Moreover, the same reference numbers are used throughout the drawings to reference like features and components.

FIG. 1 is an isometric view of a first exemplary optical disk having a label applied by a disk labeling kit in accordance with an embodiment of the present invention.

FIG. 2 is an orthographic view of a second exemplary optical disk having a label applied by a disk labeling kit in accordance with an embodiment of the present invention.

FIGS. 3-6 are exemplary tools for applying a reactive coating to an optical disk in accordance with an embodiment of the present invention.

FIG. 7 is a cross-sectional view of an exemplary fixture, showing an optical disk in the process of being stamped to include disk speed and angular orientation indicia in accordance with an embodiment of the present invention.

FIG. 8 is a cross-sectional view of an exemplary fixture for use in silk screening a reactive coating onto an optical disk in accordance with an embodiment of the present invention.

FIG. 9 is a cross-sectional view of an exemplary fixture for use in manipulating an adhesive-backed layer containing a reactive coating into alignment with an optical disk in accordance with an embodiment of the present invention.

FIG. 10 is a cross-sectional view of an exemplary fixture for use in manipulating an adhesive-backed annulus defining the speed and angular orientation indicia into alignment with the disk in accordance with an embodiment of the present invention.

FIG. 11 is a flow diagram that describes an exemplary implementation, including a method employed for using a disk labeling kit to label a disk in accordance with an embodiment of the present invention.

FIG. 12 is a diagram that describes optional implementations by which reactive coating may be applied to an optical disk in accordance with an embodiment of the present invention.

FIG. 13 is a flow diagram that describes an exemplary implementation by which an adhesive-backed layer of reactive coating may be applied to a disk in accordance with an embodiment of the present invention.

FIG. 14 is a flow diagram that describes an exemplary implementation, including a method employed for use in applying speed and angular orientation indicia to an optical disk in accordance with an embodiment of the present invention.

### DETAILED DESCRIPTION

A disk labeling kit and method of operation allows application of an after-market label to an optical disk. In one embodiment, a reactive coating is applied to a non-data surface of the optical disk. A data surface is opposite the non-data surface. An optical disk drive reads (and in some cases writes) data while interfaced to the data surface. The reactive coating on the non-data surface is typically configured for sensitivity to a laser, so that an image can be “burned” onto the reactive coating using the lasers in an optical disk drive that are typically employed for reading data from CDs and DVDs. Additionally, speed and angular orientation indicia are applied to the disk. The speed and angular orientation indicia are markings which allow hardware within a computer to detect an optical disk's speed of rotation and the orientation of the disk within a disk drive. Similarly, meta data indicia may be applied to the disk. The meta data indicia may include markings which provide the disk drive (and related hardware and software) with information concerning the specifics of the reactive coating which has been applied to the optical disk, and information on specific print modes which are configured for marking the reactive coating. Such specifics can assist, for example, in making decisions as to how long to concentrate the laser on locations on the reactive coating to achieve a desired result. Accordingly, an image is applied to the reactive coating using the speed and angular orientation indicia, as well as the meta data indicia.

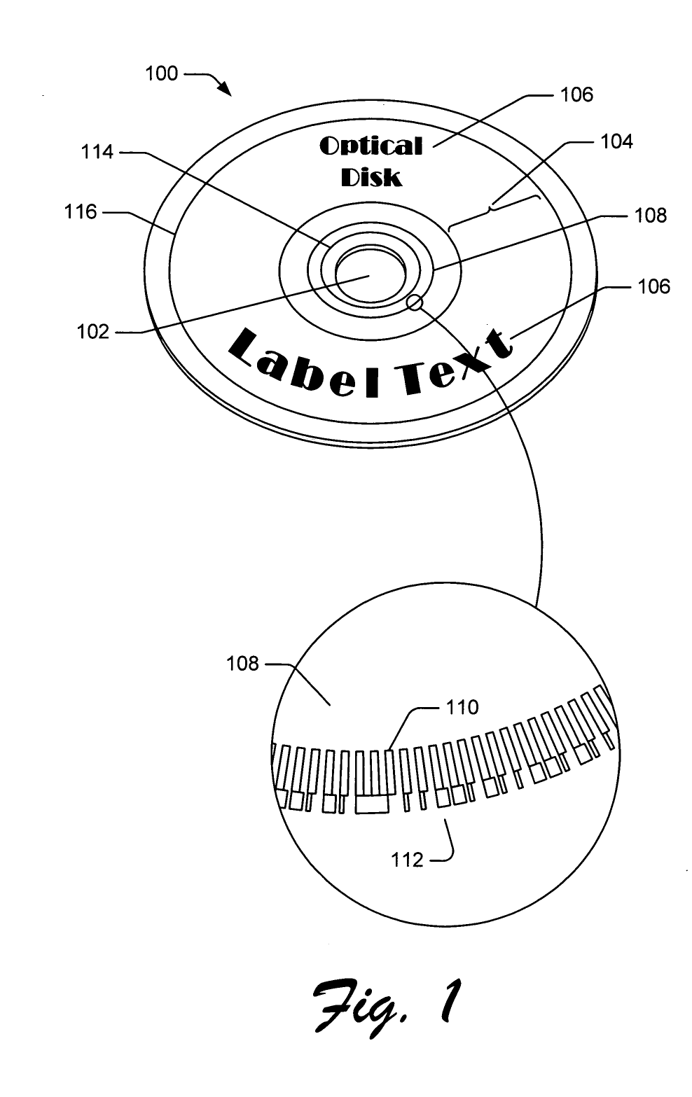

FIG. 1 is an isometric view of an upper (non-data) surface of an exemplary optical disk 100 to which a label has been applied by a disk labeling kit, as will be described with reference to additional figures, below. The exemplary disk 100 includes a central hole 102 and a label region 104, on which images 106 including text and/or graphics may be applied. The label region 104 includes a coating of reactive material, which has characteristics that allow formation of an image (such as text and graphics) as a result of exposure to a laser in an label-making device, such as an optical disk drive.

A ring 108 includes indicia conveying data which allow a determination of disk rotational speed and disk angular orientation to be made. In many cases, the ring 108 may also define meta data, which typically includes information on the type of reactive coating that is used within the label region 104.

Referring to the inset region of FIG. 1, detail of the ring 108 defining the disk speed/angular orientation and meta data is seen. An inner ring 110 includes disk speed marks. Where one mark is different and/or missing, the angular orientation of the disk may be determined. An outer ring 112 includes meta data, which is typically communicated to the disk label-making device, within which the disk 100 is inserted during the image-application process. The meta data typically includes data that tells the disk label-marking device about characteristics of the reactive coating applied to the label region 104, and other information required by the disk label-marking device. Note that in most applications, the disk label-marking device is an optical disk drive, typically having some modifications.

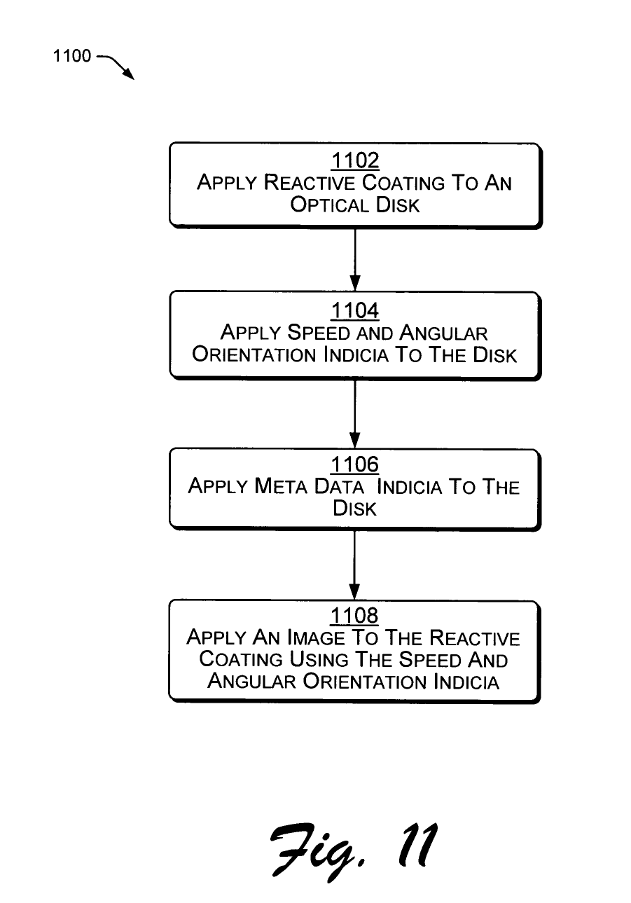

Continuing to refer to FIG. 1, the reactive coating making up the label region 104, and data ring 108 may be carried by a substrate. The substrate may be configured as a thin annulus, and may have an inner edge 114 and an outer edge 116. Application of such a substrate to such an optical disk is seen in greater detail in FIG. 9, which shows attachment of an adhesive-backed substrate 900 to an optical disk.

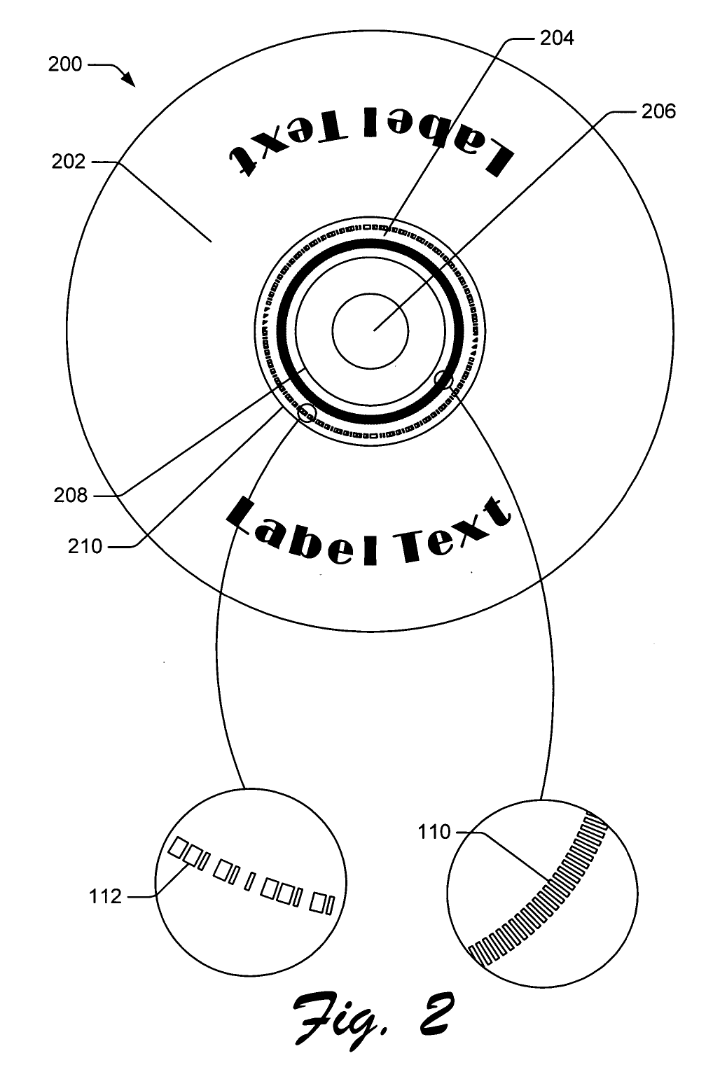

FIG. 2 is an orthographic view of a second exemplary optical disk 200 having a label which has been applied by a disk labeling kit. In a variation of the embodiment seen in FIG. 1, the disk speed indicia 110 and meta data indicia 112 are contained on an annulus 204, which is applied to the disk 200 using adhesive or other means. Continuing to refer to FIG. 2, a label region 202 results from application of reactive material to which an image including text or graphics may be applied. An annulus 204 has an inner edge 208 which is radially outward of a central hole 206, and an outer edge 210 which is radially inside the label region. As seen in the inset, the annulus 204 includes a ring 110 defining disk speed indicia. As described above, slight modification to one or more of the indicators allows determination of the angular orientation of the disk. As described above, meta data 112 typically contains information on the nature of the reactive coating within the label region 202. As will be noted in the discussion of FIG. 10, the annulus 204 may be configured with an adhesive-backing, and may be positioned on the optical disk by a user, perhaps assisted by a fixture 700 (also seen in FIG. 10).

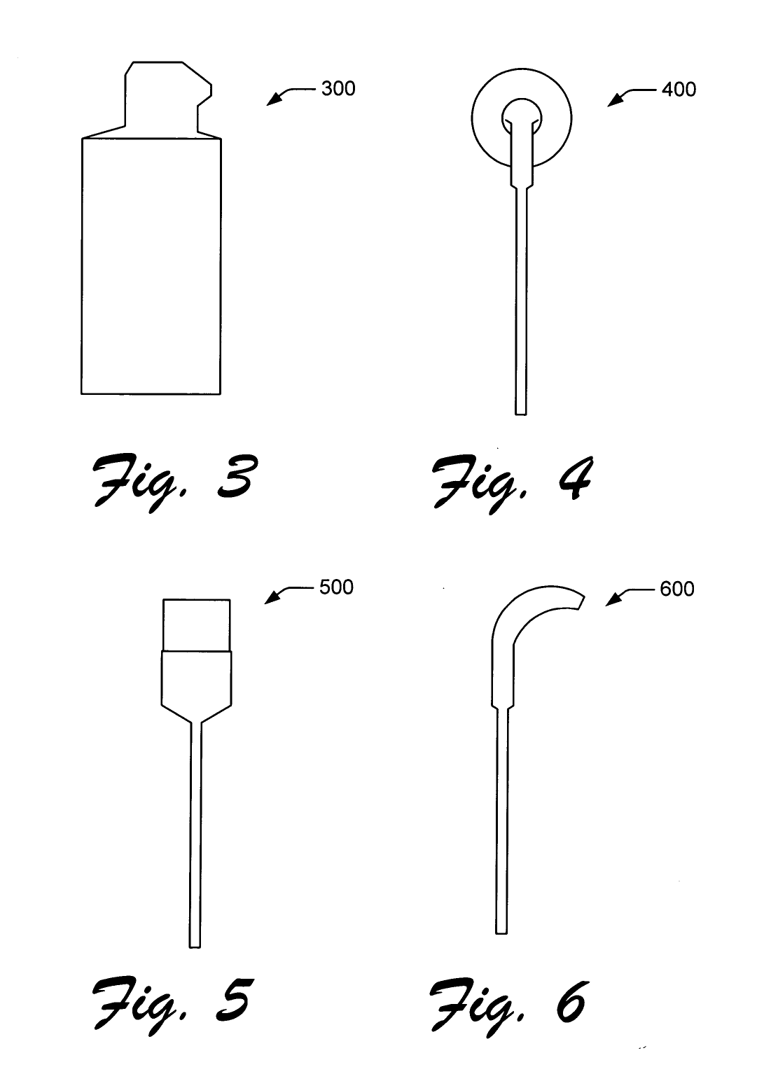

FIGS. 3-10 are exemplary of components for possible inclusion within a kit of parts for use in labeling a disk. Such a kit is useful as an after-market upgrade kit, which can be used by a consumer to apply a label to a disk that was previously purchased. Accordingly, consumers with disks in their possession, who desire to apply a label to that disk, can utilize a kit of parts having one or more of the elements illustrated in FIGS. 3-10 to apply the desired label.

FIGS. 3-6 are exemplary tools for applying a reactive coating to an optical disk. In FIG. 3, the reactive coating is contained within a spray canister 300, which allows a user to spray a layer of the reactive coating onto the disk. Where the reactive coating is provided in a kit of parts in a liquid form-and typically contained in a bottle-exemplary tools such as a roller 400, brush 500, squeegee 600 or other tool may be used to smooth the reactive coating uniformly over the disk. In general, tools 300-600 allow a user to form a thin and even layer of the reactive coating over the upper (non-data) surface of an optical disk. The region wherein the reactive coating is located therefore forms a label region, such as 104 (FIG. 1) or 202 (FIG. 2).

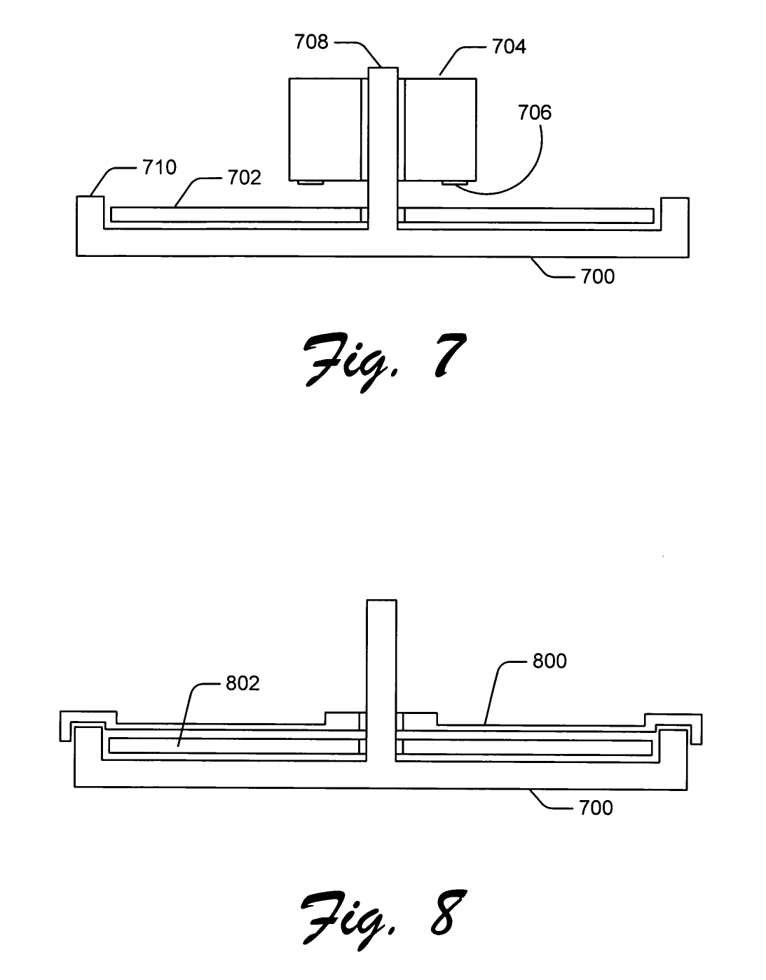

FIG. 7 is a cross-sectional view of an exemplary fixture 700, showing an optical disk 702 in the process of being stamped to include disk speed and angular orientation indicia. A stamp 704 is configured with ink pads 706 or similar marking structure that applies disk speed and angular orientation indicia, such as indicia 110 (FIG. 1) to the disk. The stamp 704 may also apply indicia conveying meta data, such as meta data indicia 112 (FIG. 1). The exemplary fixture 700 may be configured with a central axle 708 having an outside diameter incrementally smaller than the inside diameter of the hole defined in an optical disk, and an outer rim 710 having an inside diameter incrementally greater than an outside diameter of the optical disk. Accordingly, the fixture 700 is configured to hold the optical disk in position.

Stamp 704 may also be configured to include an implementation wherein pads 706 are configured to apply disk speed and angular orientation indicia 108, as well as meta data 112, through the use of heat. In particular, the stamp may be configured with heated pads 706 which mark the reactive coating carried by the surface of the optical disk, or which mark the surface of the optical disk 702 itself.

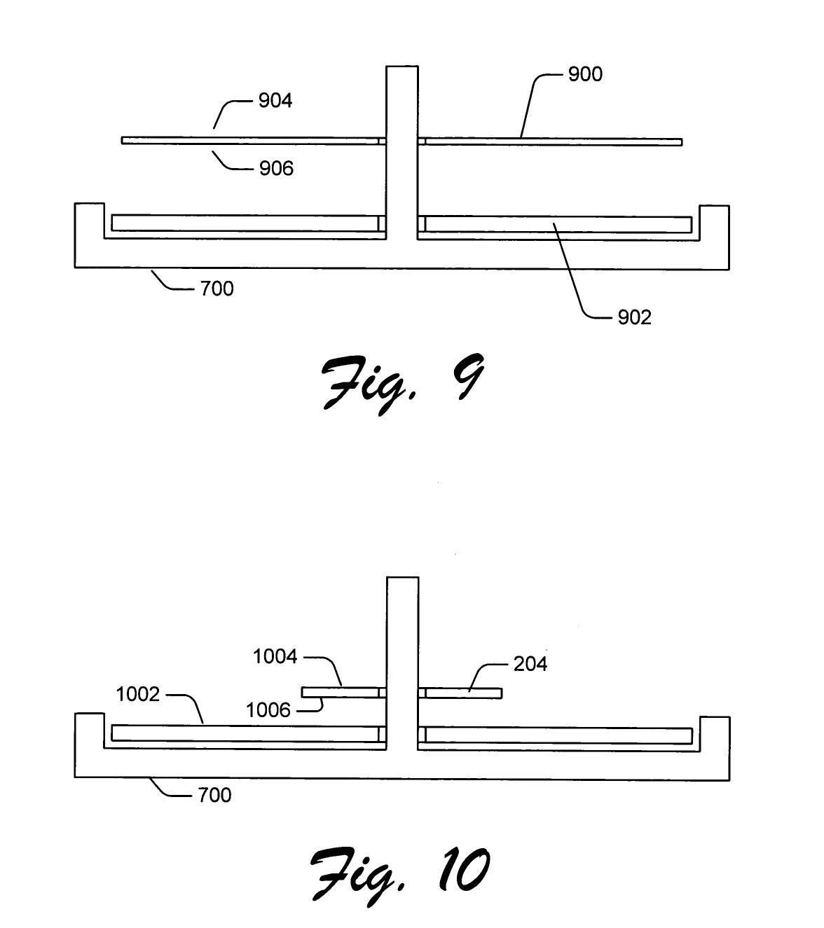

FIG. 8 is a cross-sectional view of the fixture 700 configured for use in silk screening a reactive coating onto an optical disk 702. A silk screen attachment 800 is configured to attach to the fixture 700, thereby holding both in a co-linear configuration. Using a squeegee or similar tool, a user is able to silk screen reactive coating onto the disk 802. In one implementation, the silk screen 800 is configured to apply disk speed and orientation indicia 110 (FIG. 1) and meta data indicia 112 (FIG. 1) to the disk 702.

FIG. 9 is a cross-sectional view of an exemplary fixture 700 configured for use in manipulating an adhesive-backed layer 900 containing a reactive coating into alignment with an optical disk 902. In the exemplary layer 900, the reactive coating is carried by the top 904 of the layer 900, while the adhesive coating is carried by the bottom 906 of the layer 900. In one implementation, the top 904 also includes disk speed and orientation indicia 110 and meta data indicia 112.

FIG. 10 is a cross-sectional view of an exemplary fixture 700 for use in manipulating an adhesive-backed annulus 204 into alignment for attachment to an upper (non-data) surface of an optical disk 1002. An upper surface 1004 of an exemplary annulus 204 defines speed and angular orientation indicia (e.g. indicia 110 of FIG. 1) and meta data indicia (e.g. indicia 112 of FIG. 1). A lower surface 1006 of the annulus 204 is covered with adhesive, to allow the annulus 204 to be attached to the label (non-data) side of the disk 1002. A view of the optical disk having the annulus 204 attached to the disk is seen in FIG. 2.

Continuing to refer to FIG. 10, the annulus 204 may be applied to a disk having a factory-prepared reactive coating surface, or may be applied to a disk to which a reactive coating has been added such as by use of any of the tools 300-600 seen in FIGS. 3-6. Additionally, the annulus 204 may be applied to a disk to which disk speed indicia, angular orientation indicia, and/or meta data indicia have already been applied. Such an application would allow the meta data to be changed, thereby providing a means by which the optical disk drive could be signaled to utilize a different algorithm or procedure to apply an image to the upper (non-data) surface of the disk 1002.

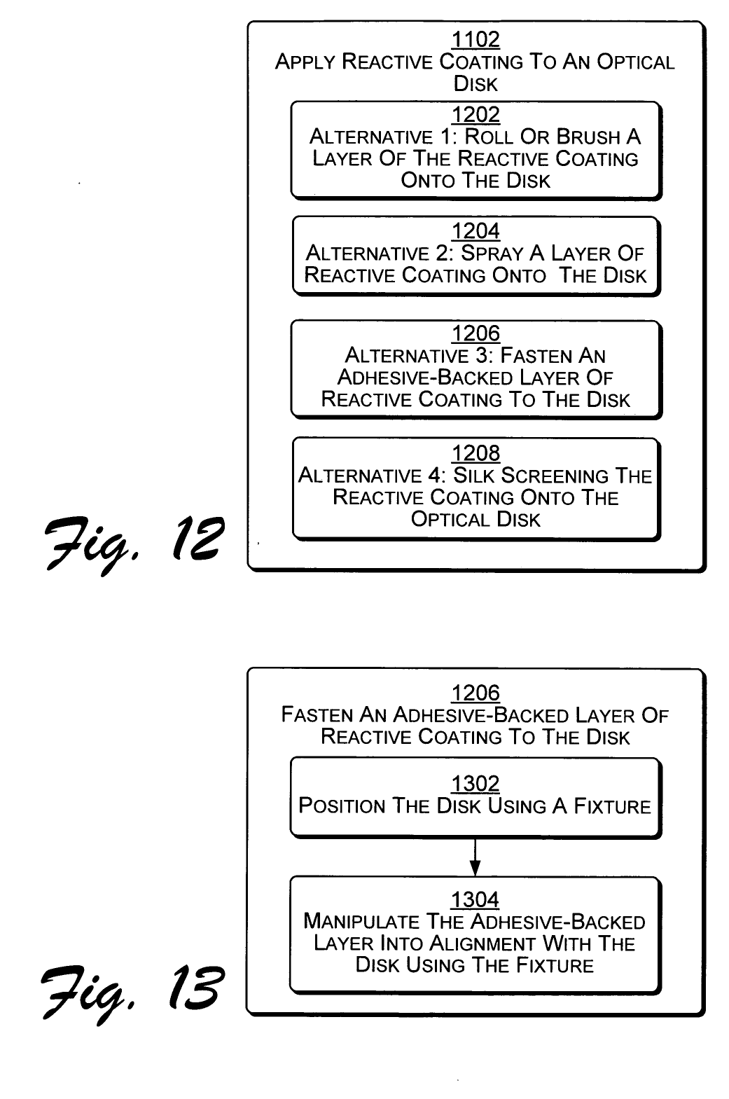

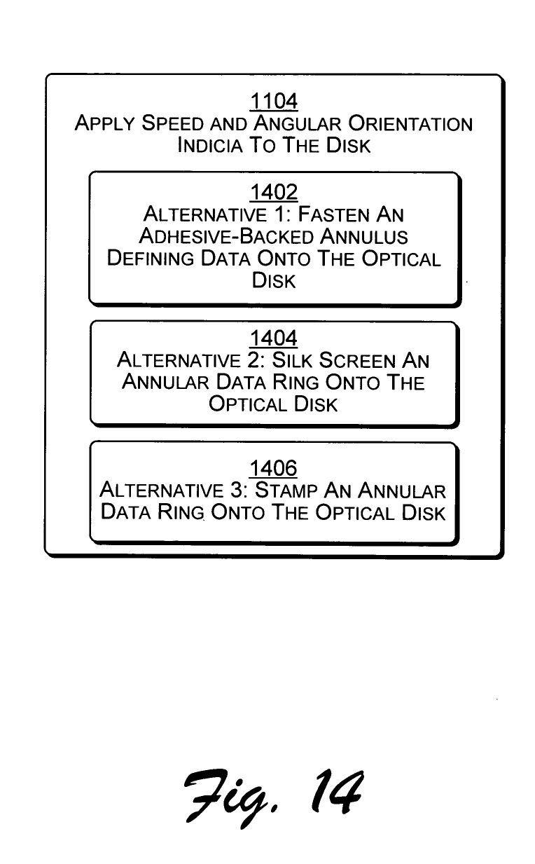

FIG. 11 is a flow diagram that describes an exemplary implementation 1100, including a method employed for using a disk labeling kit to label a disk. At block 1102, a reactive coating is applied to an optical disk. FIG. 12 shows four exemplary and alternative methods by which the reactive coating may be applied to an optical disk. In alternative block 1202, as seen in FIGS. 4 and 5, a roller 400 or brush 500 may be used to apply a uniform coating of reactive material to the label (non-data) side of an optical disk. In alternative block 1204, as seen in FIG. 3, the reactive coating may be applied to the label side of the optical disk using an aerosol spray device. In alternative block 1206, as seen in FIG. 9, the reactive coating can be applied to the optical disk as a layer having an adhesive backing. FIG. 13 outlines an exemplary implementation by which the adhesive-backed layer may be attached. At block 1302, the disk is positioned within a fixture 700, as seen in FIG. 9. At block 1304, the adhesive-backed layer 900 is manipulated into alignment with the disk using the fixture. The fixture 700 allows the adhesive-backed layer having a reactive coating to be positioned co-axially with the disk 700. In alternative block 1208, as seen in FIG. 8, the reactive coating can be applied to the optical disk using a silk screen 800.

At block 1104 speed and angular orientation indicia are applied to the optical disk. FIG. 14 shows three exemplary and alternative methods by which the speed and angular orientation indicia may be applied to the optical disk. It should be noted that meta data, describing the reactive coating and other factors relevant to the application of an image to the reactive coating, could also be added in a manner similar to that disclosed in FIG. 14. In an alternative implementation seen at block 1402, the annulus 204 of FIG. 10 having the speed and angular orientation indicia defined thereon may be applied to the optical disk in a method similar to that of FIG. 13, using structures similar to those seen in FIG. 10. In an alternative implementation seen at block 1404, an annular data ring containing disk speed and angular orientation information (and optionally, meta data) may be silk screened onto the optical disk. The silk screening may be performed using the fixture 700 and silk screen 800 seen in FIG. 8. In an alternative implementation seen at block 1406, an annular data ring is stamped onto the optical disk. The stamping process may be performed by a stamp 704, as seen in FIG. 7.

At block 1106, meta data indicia are applied to the optical disk. The exemplary embodiments of FIG. 14, used for application of speed and angular orientation indicia, are also available for use in applying meta data. Although meta data can be configured to describe almost anything, in one implementation, the meta data describes or provides information on the reactive coating, laser marking parameters, and its chemistry, print modes configured for applying an image or text to the reactive coating, media manufacturing data and data describing other factors relevant to marking the reactive coating.

At block 1108, an image is applied to the reactive coating using data derived from the speed and angular orientation indicia. The image application process may optionally utilize the meta data indicia in some applications. Uses for meta data include, but are not limited to: indication of an intended print mode; and communication of reactive coating information. For example, where the meta data conveys intended print mode information, disk speed and laser intensity information may be set according to the intended print mode. Similarly, where reactive coating information is conveyed, disk speed, laser intensity and other settings may be configured appropriately, in view of specifics of the reactive coating disclosed by the meta data.

Although the disclosure has been described in language specific to structural features and/or methodological steps, it is to be understood that the appended claims are not limited to the specific features or steps described. Rather, the specific features and steps are exemplary forms of implementing this disclosure. For example, while, actions described in blocks of the flow diagrams may be performed in parallel with actions described in other blocks, the actions may occur in an alternate order, or may be distributed in a manner which associates actions with more than one other block.

1. A method of applying an after-market label to a disk, comprising:
applying a reactive coating to a non-data surface of the disk;
applying speed and angular orientation indicia to the disk; and
using the speed and angular orientation indicia to apply an image to the reactive coating, while rotating the disk within an optical disk drive.

2. The method of claim 1, additionally comprising applying meta data indicia to the disk, wherein the meta data indicia describes the reactive coating.

3. The method of claim 2, wherein applying speed and angular orientation indicia comprises applying the speed and angular orientation indicia in an annular configuration.

4. The method of claim 1, wherein applying speed and angular orientation indicia comprises applying the speed and angular orientation indicia in two concentric rings.

5. The method of claim 1, wherein applying the reactive coating comprises:
rolling the reactive coating onto the non-data surface of the disk.

6. The method of claim 1, wherein applying the reactive coating comprises:
spraying the reactive coating onto the non-data surface of the disk.

7. The method of claim 1, wherein applying the reactive coating comprises:
fastening an adhesive-backed layer containing the reactive coating to the non-data surface of the disk.

8. The method of claim 7, wherein fastening the adhesive-backed layer comprises:
positioning the disk using a fixture; and
manipulating the adhesive-backed layer into alignment with the disk using the fixture.

9. The method of claim 1, wherein applying the reactive coating comprises:
silk screening the reactive coating to the non-data surface of the disk.

10. The method of claim 9, wherein applying speed and angular orientation indicia to the disk is performed during the silk screening.

11. The method of claim 1, wherein applying speed and angular orientation indicia to the disk comprises:
positioning the disk using a fixture; and
manipulating an adhesive-backed annulus defining the speed and angular orientation indicia into alignment with the disk using the fixture.

12. A kit of parts for use in labeling a disk, comprising:
reactive coating material adapted for layered application to a non-data surface of the disk and for reaction with a laser beam to form visible labeling on the non-data surface; and
an adhesive backed annulus with indicia indicative of parameters to control application of the laser beam to the reactive coating material, wherein the annulus is adapted for attachment to the non-data surface.

13. The kit of parts of claim 12, additionally comprising:
an applicator configured for applying a layer of the reactive coating material to the disk.

14. The kit of parts of claim 12, wherein the indicia indicate disk speed and angular orientation information.

15. The kit of parts of claim 12, additionally comprising:
a fixture for use in aligning the adhesive backed annulus and the disk to allow coaxial attachment of the adhesive backed annulus to the disk, wherein the adhesive backed annulus is additionally configured to include meta data describing the reactive coating material.

16. The kit of parts of claim 12, additionally comprising:
a fixture for use in aligning the disk and an adhesive-backed sheet supporting the reactive coating material.

17. The kit of parts of claim 12, wherein the applicator comprises:
an aerosol container for spraying on the reactive coating material.

18. The kit of parts of claim 12, wherein the applicator comprises:
a squeegee for smoothing on the reactive coating material.

19. The kit of parts of claim 12, wherein the adhesive-backed annulus is configured to include media information data.

20. The kit of parts of claim 12, wherein the adhesive backed annulus is configured to carry the reactive coating material.

21. An after-market upgrade kit of parts for an optical disk, comprising:
a layer of reactive material for application to a non-data surface of the optical disk, wherein the layer of reactive material is configured to receive an image in response to exposure to a laser beam; and
an annulus configured for application to the non-data surface of the optical disk.

22. The after-market upgrade kit of parts of claim 21, wherein the annulus defines speed and position data.

23. The after-market upgrade kit of parts of claim 21, wherein the annulus is additionally configured to include meta data identifying characteristics of the reactive material.

24. The after-market upgrade kit of parts of claim 21, wherein the annulus is additionally configured to include an adhesive layer for attachment to the non-data surface of the optical disk.

25. A method of performing an after-market upgrade on an optical disk, comprising:
coating a layer of reactive material on a non-data surface of the optical disk, wherein the layer of reactive material is configured to receive an image in response to exposure to a laser beam; and
defining indicia on the optical disk in an annular pattern indicating speed and angular orientation information.

26. The method of claim 25, additionally comprising:
defining meta data indicia on a non-data surface of the optical disk.

27. The method of claim 25, wherein coating the layer comprises:
spraying on the layer of reactive material.

28. The method of claim 25, wherein coating the layer comprises:
brushing on the layer of reactive material.

29. The method of claim 25, wherein coating the layer comprises:
attaching the layer of reactive material with adhesive-backing.

30. The method of claim 25, wherein defining the speed and position indicia comprises:
stamping the speed and position indicia onto the optical disk.

31. The method of claim 25, wherein defining the speed and position indicia comprises:
fastening the speed and position indicia onto the optical disk with adhesive-backing.

32. The method of claim 25, wherein defining the speed and position indicia comprises:
silk screening the speed and position indicia onto the optical disk.

33. An after-market upgrade kit of parts for an optical disk, comprising:
an annulus defining label-marking information, wherein the annulus is configured for application to the optical disk.

34. The after-market upgrade kit of parts of claim 33, wherein the label-marking information comprises speed and angular orientation data.

35. The after-market upgrade kit of parts of claim 33, additionally comprising a layer of reactive material for application to a non-data surface of the optical disk, wherein the layer of reactive material is configured to receive an image in response to exposure to a laser.

36. The after-market upgrade kit of parts of claim 35, wherein the annulus is additionally configured to include meta data identifying characteristics of the reactive material.

37. The after-market upgrade kit of parts of claim 33, wherein the annulus is additionally configured to include an adhesive layer for attachment to the optical disk.

38. A kit of parts for applying an after-market label to a disk, comprising: means for applying a reactive coating to a non-data surface of the disk; means for applying speed and angular orientation indicia to the disk; and
means for applying meta data indicia to the disk, wherein the meta data indicia describe the reactive coating.

39. The kit of parts of claim 38, additionally comprising means for using the speed and angular orientation indicia to apply an image to the reactive coating.
